(19) United States
(12) Patent Application Publication
(10) Pub. No.: US 2025/0362269 A1
(43) Pub. Date: Nov. 27, 2025

(54) STRESS CONCENTRATION MAPPING IN INSULATED PIPEWORK

(71) Applicant: Speir Hunter Ltd, Nottingham (GB)

(72) Inventors: Chau VO, Nottingham (GB); Yongze GAN, Nottingham (GB); David TWEDDLE, Nottingham (GB); Hamed HABIBI, Nottingham (GB)

(73) Assignee: Speir Hunter Ltd, Nottingham (GB)

(21) Appl. No.: 19/226,436

(22) Filed: Jun. 3, 2025

Related U.S. Application Data
(63) Continuation of application No. 17/926,787, filed on Nov. 21, 2022, now abandoned.

(30) Foreign Application Priority Data
May 22, 2020 (GB) 2007712.9

(51) Int. Cl. G01N 27/87; F16L 101/30

(52) U.S. Cl. CPC G01N 27/87; F16L 2101/30

(57) ABSTRACT

A magnetic inspection system and method for detecting and mapping magnetic anomalies in a section of pipe. The inspection system includes a probe with first and second arrays of magnetic field sensors arranged in first and second layers such that the first and second arrays are spaced from the section of pipe under inspection by different radial distances. Data from the probe is used to create a graphical representation of the inspected area.

### CROSS REFERENCE TO THE RELATED APPLICATIONS

The present application is a continuation application of U.S. application Ser. No. 17/926,787, filed on Nov. 21, 2022, which is a national stage application of PCT international application PCT/GB2021/000058, filed on May 24, 2021, which claims the benefit of priority from the United Kingdom Application No. 2007712.9, filed on May 22, 2020, the disclosure of which is hereby incorporated by reference in its entirety.

### FIELD

The present invention relates to a magnetic inspection system and method, in particular for detecting and mapping magnetic anomalies in a section of pipe.

### BACKGROUND

Corrosion under insulation (CUI) is a form of damage that occurs in insulated pipework found in facilities such as refineries and process plants. The corrosion typically occurs when moisture, for example from steam, is absorbed by or passes through the insulation on the pipes. The resulting corrosion/damage can be highly localised, and if undetected can result in failure of the pipe.

Inspection of insulated pipework in these facilities can be difficult due to access problems, and the facilities often operate a high temperatures making inspection operations unpleasant. A faster or more efficient inspection method for such facilities would therefore be beneficial.

It is known to use magnetic field readings to detect stress concentration regions in a pipeline, and thus provide an indication of the location of defects or regions of reduced structural integrity in the walls of the pipeline. One benefit of such systems is that inspection can be carried out remotely, avoiding the need to unearth each section of buried pipeline for inspection, and without any need to introduce a physical ‘pig’ into the pipeline.

Broadly speaking, the known systems operate by measuring magnetic field levels as sensors are moved along the length of a known pipeline, and associating the readings with a timestamp and location from a GPS sensor. The data is then processed to detect anomalies, and these provide an indication of the longitudinal positions of potential defects. This avoids unnecessary excavation of the pipeline, because the position data from the inspection can then be mapped back onto the pipeline so that any excavation can be focused on the repair site.

To date, systems of this type have been limited to the inspection of relatively large diameter pipelines in isolated locations, and are required only to provide a defect position along the length of a pipeline with sufficient accuracy to allow targeted excavation around the defect location.

### SUMMARY

According to a first aspect of the invention there is provided an inspection system as defined in the appended claim 1. Further optional features are recited in the associated dependent claims.

Also provided is a method of inspecting a section of pipe as defined in appended claim 15, and a data carrier as defined in the appended claim 24. Further optional features for these aspects are recited in the associated dependent claims.

It was an aim of the invention to develop a portable magnetic scanner capable of assessing the integrity of pipes under insulation through interpretations of the pipe's magnetic field. To achieve this, the scanning instrument is required to collect and build images of the passive magnetic field induced by the target pipe. Data collected by the instrument is to be analysed in order to detect defects in the pipe wall on site by the instrument operator, and to allow more detailed analysis off-site by a data analyst. It may be possible to identify the location of any defect detected on the inspected section of target pipeline post-analysis, in addition to being marked on the pipe at the time of inspection, where appropriate.

To ensure precise magnetic measurements are collected, mechanical motion parts may be included to control any potential negative impact on collected data and subsequent analysis pertaining from uncontrolled variables such as positional accuracy, speed and exact direction of scans.

The inspection is passive rather than active. In other words, no external energy is applied to the section of pipe under inspection to highlight anomalies. The sensors simply detect anomalies in the earth's own magnetic field arising from defects or similar in the pipe walls. Active detector systems are known, but typically rely on direct contact with the pipe wall to transfer the energy, meaning that insulation needs to be removed before inspection can be carried out. The solution of the claimed invention beneficially allows assessment of the pipe condition under the insulation without the need to first strip insulation or cladding from the pipe.

The inspection system, for detecting and mapping magnetic anomalies in a section of pipe, comprises a probe comprising a plurality of magnetic field sensors and a data logger for recording collected magnetic data measured by the magnetic field sensors. The probe comprises first and second arrays of magnetic field sensors arranged in first and second layers respectively so that, in use, the second layer of magnetic field sensors is spaced from the section of pipe under inspection by a greater radial distance than the first array of magnetic field sensors.

The data logger may be provided as a separate component, spaced from the probe, or may be distributed between the probe and a processor or another component. The probe may comprise magnetic field sensors, an inertial measurement unit (IMU) to measure acceleration and/or angular velocity of the probe, and a data transmitter for transmitting magnetic field data and motion data from the probe to a processor component, embodied for example in/as a computer, tablet or similar. The data transmitter may be a wireless transmitter. A remote controller may be provided, and may comprise a power supply, such as a rechargeable battery, to power the probe via a suitable power cable. The power cable should be at least 1-2 metres in length to allow use of the probe at a distance from the remote controller. A user interface, for example one or more buttons and indicator light may be provided to allow control of the probe and/or the processor. The communication between the remote controller and the processor may be via a wired or wireless connection.

The sensors may be three-axis magnetometers. The inspection system may provide a dense arrangement of many magnetic sensors in three dimensions, to achieve a resolution of, e.g. less than ten millimetres. Three or more layers of sensors may be provided, and odd or even numbers of layers are possible. Additional layers beyond the first and second arrays may comprise further arrays and/or just individual sensors.

The first array and/or the second array may comprise 4, 8, or 16 magnetic field sensors. Alternative numbers of sensors may be provided in the first and/or second array, and each array may comprise odd or even numbers of sensors. For example, either or both of the first and second array may comprise 3, 5, 6, 7, 9, 10, 11, 12, 13, 14, 15 or more magnetic field sensors.

The arrangement of magnetic field sensors in the first array may be the same as the arrangement of magnetic field sensors in the second array. The first and second arrays may be substantially identical.

The inspection system may further comprise a power source for the probe, wherein the probe is remote from power source. For example, the data logger or the remote controller may comprise the power source. The probe may have a wired connection to the power source.

The probe may comprise an inertial measurement unit to measure motion of the probe, and a data transmitter for transmitting magnetic field data and motion data from the probe to a processor component. Information about the movement of the probe can thereby be gathered along with the magnetic field data and used to improve the quality of the data. In particular, if a probe is moved by hand, without external support, the movement data can be captured and processed to compensate for any irregularities in the probe movement speed or direction. The transmission may be wireless, and/or may be directly from the probe to the processor component or via an intermediate component such as a dedicated data logger.

The inspection system may further comprise a remote controller with a user interface for controlling the probe and/or the processor component.

The probe and the system overall have been designed to have a small size to provide a portable system and allow access for inspection of crowded networks of pipes. Providing an inbuilt power source helps to make the system portable.

The inspection system may further comprise a mechanical support for guiding or constraining movement of the probe relative to a section of pipe during inspection.

The mechanical support may comprise a powered drive, for example one or more electric motors, for moving the probe. Alternatively, an operator may move the probe manually, using a mounting on the mechanical support or the entire mechanical support for guidance only.

The support may be specifically designed to assist with positioning or movement of a ring-shaped probe or a plurality of probes along a length of pipe such that inspection can cover all or a majority of a pipe circumference in a single pass.

The inspection system may further comprise a processor, connected to the data logger or to the remote controller, for processing the magnetic field data. The processor may be integrated into the inspection system, or may be provided within a standard computer, laptop, tablet or smartphone running bespoke software.

The plurality of magnetic field sensors may comprise a plurality of three-axis magnetometers which detect three orthogonal components of a magnetic field, and the processor may resolve the three components of magnetic field data from the three axes to calculate a single numerical value for each reading.

Each reading may correspond to a single location on the pipe but may comprise readings from a plurality of three-axis magnetometers. For example, each reading may include a magnetic field gradient in each axis calculated from two or more magnetometers spaced in the direction of each axis.

The processor may arrange the processed collected magnetic data based on location to provide a visual representation or map of the section of pipe under inspection.

The inspection system may further comprise a display for displaying a graphical output of the processed collected magnetic data. The display may be provided by a standard computer, laptop, tablet or smartphone running bespoke software.

The probe may be configured to accommodate the circumference of the section of pipe under inspection.

The small size of the probes, for example L100 mm×W40 mm×H25 mm, generally makes it possible to follow the radius of a pipe sufficiently closely during inspection. However, a range of probes could be provided with curved surfaces having radii of curvature corresponding to common insulated or uninsulated pipe diameters, or probes could be made flexible or articulated to allow manipulation in a plane to surround or partially surround the pipe wall. Ring-shaped probes capable of providing sensor arrays completely surrounding pipes could also be provided, possibly with a hinge to allow the probe to be positioned around a pipe in-situ. Frames supporting a plurality of individual probes could also be provided as an alternative way to surround a pipe section.

The close spacing of pipes in facilities is problematic both for access to a particular section of pipework and because of potential interference from nearby pipe sections in readings. The invention addresses the problem by providing a compact device, capable of manipulation by hand, and through incorporating sensors arranged in two or more layers to aid in cancellation of erroneous readings from adjacent or nearby sections of pipe. The two or more layers provide, in use, different radial spacings from the pipe under inspection for two or more groups of sensors. Due to the relative proximity of the sensors to the section of pipe under inspection, the two or more groups of sensors will provide noticeably different readings relating to the section of pipe under inspection, but any background readings, from nearby pipework or other elements, will be detected almost equally. This use of these magnetic field gradients allows the background readings to be cancelled during processing.

In contrast to large scale outdoor pipeline inspection, the application of the system as proposed is on relatively short sections (a few metres) of smaller diameter pipe within often densely populated plants and facilities. The magnetic field needs to be consistently measured with a spatial resolution of a few millimetres in order to fully explore the magnetic field in the volume around the target pipe section. The use of GNSS/GPS for location stamping the data is unsuitable at this scale of operation (the location data would also need to be accurate in the range of tens of mm) and in such environments. The environment is also problematic for deployed local reference points, as are required working time restraints. Relative positioning can be used, but risks introducing further interference into the readings.

Images can be built up during use of the probe, typically showing a flattened image of a section of the pipe wall, for example a half circumference of the pipe section under inspection. The probe may be manually swept around the pipe circumference during movement along the inspected section to build up an image, or may be sized and shaped to cover a section (for example a quarter of half circumference) of the pipe as it is moved along the pipe. It is also envisaged that a probe in the general form of a ring could be produced to build an image of the entire wall of a section of a pipe during a single pass where access allows.

A mechanical frame or system can be used to constrain movement of the probe during inspection and assist in the necessary detection and building of an image. A frame of this type can also provide accurate positional data while avoiding some of the drawbacks mentioned above, and opens up the possibility of an automated scanning process using appropriate motor drive and control algorithms known to a skilled reader.

In a further development, a system for ongoing maintenance and monitoring could be provided by positioning a probe permanently in a region where a defect is detected during inspection as already described. The output and positional data would allow a probe to be appropriately located to monitor a region where CUI has been detected, but at a relatively minor level. Ongoing monitoring of such positions within a network of pipes would allow threshold values to be set allowing preventative maintenance to be scheduled once the damage from CUI reaches unacceptable levels. This potentially reduces the number of full inspections required, improving the facility's efficiency of operation.

The claimed method of inspecting a section of pipe comprises the steps of:
A. moving a probe comprising a plurality of magnetic field sensors along a predefined path over a selected section of pipe, the predetermined path being spaced from the surface of the pipe;
B. collecting magnetic field data and corresponding location data during the movement; and
C. compiling a graphical representation of the magnetic field over the selected section of pipe from the magnetic field data and location data.

The path may be spaced from the pipe by the presence of insulation or cladding. During inspection, a processor can automatically stitch the data together to provide a graphical representation, e.g a three dimensional plot over an area representing a flattened section of pipe wall. The graphical representation can be displayed on a display screen and/or output as an electronic and/or hard for later inspection.

Step A of the method may comprise moving the probe in a serpentine path over the selected section of pipe. The collection of data may be continuous during movement of the probe, or may take the form of a series of distinct passes or ‘stripes’.

Step A may comprise initially moving the probe in a direction along the length of the selected section of pipe or initially moving the probe in a direction around the circumference of the selected section of pipe.

Step A of the method may comprise manually moving an unsupported probe. Providing a probe with means to record and transmit movement data allows the system to compensate for irregular movement of the probe during inspection.

Method steps B and C may be performed substantially in real time during movement of the probe in step A, so that an image is build up during movement of a probe for immediate inspection.

The method may comprise the further steps, after at least steps A and B, of:
D. Identifying an anomaly in the magnetic field data;
E. Determining the location of the identified anomaly on the selected section of the pipe; and
F. positioning a static probe comprising a plurality of magnetic field sensors at said location.

The static probe may be ring shaped, to completely surround the pipe, or may be positioned to focus on the specific location. A plurality of static probes may be provided, either at different positions along a length of pipe or at different positions around a pipe circumference.

The or each static probe may be permanently or semi-permanently fixed at a location, and may thus provide ongoing monitoring of an area of potential damage over time to avoid or minimise repeated full inspection operations.

The method may comprise the further, initial, step of performing a calibration operation on the probe.

The method may be performed using the system as previously described.

Also provided is a data carrier as defined in the appended claim 20. The data carrier comprises machine readable instructions for the operation of one or more processors to receive magnetic field data and corresponding location data during movement of a probe comprising a plurality of magnetic field sensors over a selected section of pipe and stitch the received data together to provide a graphical representation of the magnetic field over the selected section of pipe.

The movement may be continuous during data collection. The probe may be spaced from the pipe wall during movement, for example by insulation of cladding.

The graphical representation may comprise a three dimensional plot over an area representing the wall of the selected section of pipe.

The machine readable instructions for the operation of one or more processors may further comprise instructions to process separate components of magnetic field data at each location to provide a single reading at each location.

The machine readable instructions may further comprise instructions to receive movement data during movement of said probe.

The machine readable instructions may further comprise instructions to calculate defect indications and determine location of defects using components of magnetic field and motion data, and/or to calibrate magnetic field sensors and/or an inertial measurement unit in the or each probe.

The data carrier may be for use in a method as previously described.

### BRIEF DESCRIPTION OF THE DRAWINGS

Practicable embodiments of the invention are described in further detail below with reference to the accompanying drawings, of which:

FIG. 1 shows a schematic view of an inspection system according to the present invention;

FIG. 2 shows an indicative section of pipe with a first scanning path;

FIG. 3 shows an indicative section of pipe with a second scanning path;

FIG. 4 shows a perspective view of a mechanical support system;

FIG. 4A shows a perspective view of an alternative mechanical support system;

FIG. 4B shows a perspective view of an alternative mechanical support system;

FIG. 5 shows an example data logger for the system of FIG. 1;

FIG. 6 shows a single array of eight sensors for use in a sensor probe according to the present invention;

FIG. 7A show and end view of an array of sensors arranged in layers;

FIG. 7B show and end view of an array of sensors arranged in layers;

FIG. 7C show and end view of an array of sensors arranged in layers;

FIG. 8 shows three plots of raw magnetic field data obtained from a first test sample;

FIG. 9 shows three plots of magnetic field gradient data obtained from a first test sample;

FIG. 10 shows an alternative representation of the plots of FIG. 9;

FIG. 11 shows plots of data from the first test sample processed using two different processing methods;

FIG. 12 shows plots similar to FIG. 11 using processed data from a second test sample;

FIG. 13 shows plots similar to FIG. 11 using processed data from the second test sample with insulation and cladding present;

FIG. 14 shows a calibration rig; and

FIGS. 15A and 15B show plots of data from a sensor probe before and after calibration; and

FIG. 16 shows a schematic view of an alternative inspection system according to the present invention.

### DETAILED DESCRIPTION OF THE EMBODIMENTS

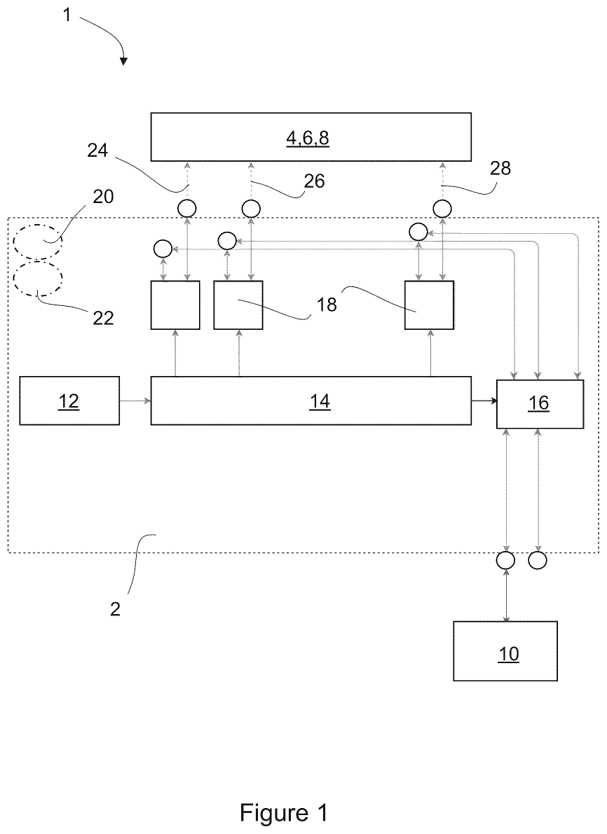

A schematic diagram of an example inspection system 1 is shown in FIG. 1. It includes a data logger 2 at the heart of the system, which accommodates the connection of multiple magnetic sensors probes 4, 6, 8 as well as a mechanical system 10 for movement of the probes 4, 6, 8 during scanning. The data logger 2 also houses a power supply 12 and a power distribution rail 14 which distributes power to a controller 16 and to individual probe controllers 18 associated with the sensor probes 4, 6, 8. A power switch 20 and power indicator 22, for example a power light/led, are also provided.

The magnetic sensor probes 4, 6, 8 are connected to the data logger 2 by lengths of cable 24, 26, 28 so that they can be used at a distance remote from the data logger 2. Due to the fact that this technology aims to measure the passive magnetic field of a target pipeline, each sensors probe 4, 6, 8 contains only the magnetic sensors along with the absolute minimum number of parts required for it to function satisfactorily to reduce the impact of any sources of magnetic interference, for example a power supply 12. As such, nothing other than the probe(s) 4, 6, 8 should be in close proximity to the section of pipeline under inspection at the time of data collection.

The inspection system 1 communicates with a bespoke software application running simultaneously on a laptop. The software application communicates with the data logger 2 and the mechanical system 10 to stamp magnetic data with location data. High-speed communication is provided with the data logger 2 and mechanical system 10 for data transmission. The software application may support user interface for future developments such as visualising, analysing data, and/or defect detection. The software application may support parameterised configuration and may run on popular operating systems.

Each magnetic sensors probe 4, 6, 8 contains arrays of magnetic field sensors, such as three-axis vector magnetometers, arranged in three dimensions. This increases the speed of imaging the collected magnetic field and increases the efficiency of mapping an image of the aforementioned field, as opposed to using a single magnetic sensor which would require a large amount of time to collect and image the magnetic field.

Other inspection methods typically rely on point measurements taken through direct contact of a probe with the outer surface of the pipe wall. A grid of inspection locations is provided, and the operator has to stop to collect data at one point before moving to the next point

The improvements made in the present system allow an alternative method where the operator can instead keep scanning continuously. Data quality is still adequate to perform magnetic tomography, building images of the magnetic field around the target pipeline or pipe section.

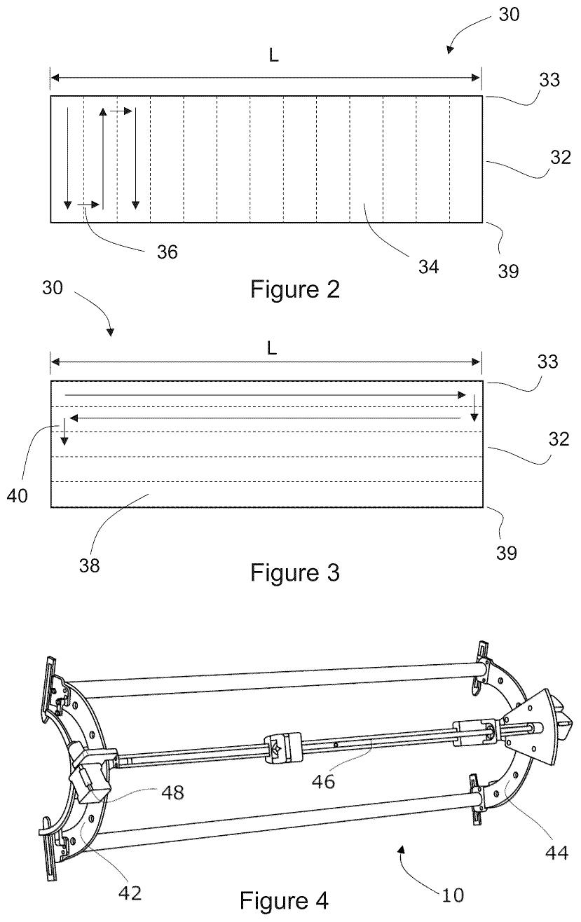

FIGS. 2 and 3 show alternative scanning paths for a section of pipe 30 under inspection, in both cases covering the top half of the pipe. For ease of reference, positions around the section of pipe 30 under inspection are assigned clock positions. The top centre of the pipe 32 is designated twelve O'clock, with the two sides 33, 39 respectively designated three and nine O'clock.

The scanning method of FIG. 2 divides the length L of the pipe section 30 into a number of equally sized passes 34 which can be marked out directly on the pipe wall or insulation or on a separate sheet. The width of each pass 34 can be selected to correspond to the size of a sensors probe 4, 6, 8 used in the inspection method. In use, the probe 4, 6, 8 is first swept along the first pass 34 from three O'clock 33 to nine O'clock 39 before moving to the second pass and being swept back from nine O'clock 39 to three O'clock 33, as indicated by arrows 36. The relatively short sweeps around the pipe section make it easier for a user to maintain accuracy and constant speed, but the number of sweeps is potentially time consuming during marking and inspection. An alternative, particularly for manual manipulation of the or each probe 4, 6, 8, is to repeatedly scan along the first pass 34, as shown in FIG. 2, from three O'clock 33 to nine O'clock 39bso that the sweep is always conducted in the same direction.

FIG. 3 illustrates an alternative scanning method where the pipe section 30 is instead divided along its length L. As in FIG. 2, each of the equally sized passes 38 can be selected to correspond with the size of a sensors probe 4, 6, 8. The inspection path 40 in FIG. 3 involves a user sweeping a probe 4, 6, 8 along the entire length L of the pipe section adjacent the three O'clock location 33, before moving across to the next pass 38 and sweeping back along the entire length L of the pipe section 30. This alternative method provides fewer passes, improving efficiency in marking and inspection. However, there is an increased risk of error in the readings due to the longer individual passes that must be made.

Each ‘working area’ of pipework when completing a scan will have a length L of no more than a few metres, so in order to stamp magnetic data with useful “location” data, the probe movement must be tracked to an accuracy of within tens of millimetres. The main intended operating environment, namely plants and densely populated facilities, makes the use of a Global Navigation Satellite System (GNSS) impractical. Deploying local reference points as base stations on site to track the sensors probe has been considered, but is not considered optimal because of working time and environment constraints.

A relative positioning technique has been deemed as an appropriate solution in this application. However, this technique introduces inherent risk due to an increase in the number of parts required within the sensors probe, in turn increasing the probability of magnetic interference. To fully explore and stamp the location of collected magnetic field data with positioning data at this stage, a mechanical system has been developed to limit or actively control the movement of the probe(s).

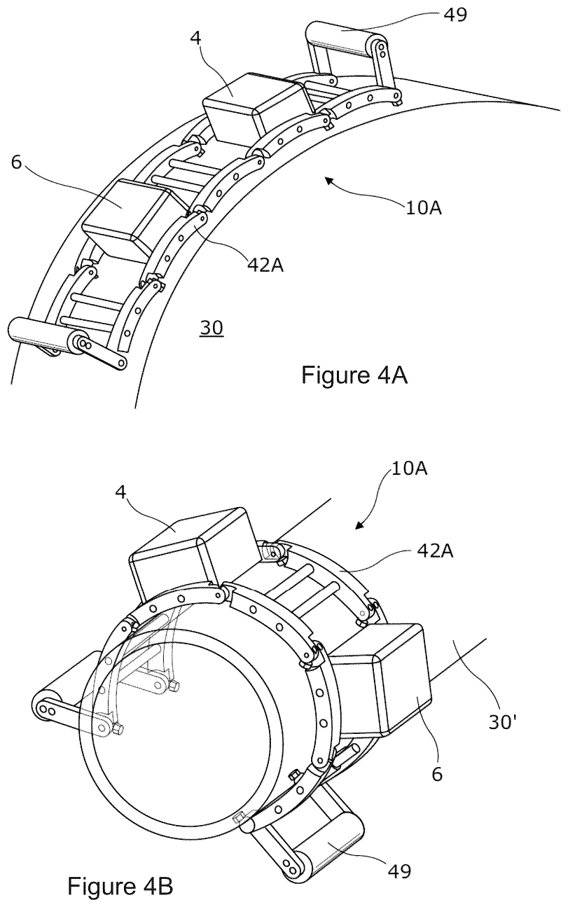

A first example of a mechanical support system 10 for controlling or limiting movement of the probe(s) 4, 6, 8 during data collection is shown in FIG. 4. In the example, the mechanical system 10 is motor driven and controlled by the software. As an alternative, the probes 4, 6, 8 can be manually moved by a user with the support system 10 merely providing support and guidance to ensure that the passes 34, 38 are completed as intended. Data collected by the probe(s) 4, 6, 8 is transmitted back to the application for visualisation and future processing purposes.

The mechanical support system 10 comprises curved ends 42, 44 providing a circumferential frame capable of accommodating 2″-6″ diameter pipes, and an axial frame 46 one metre in length, that can be advanced along the circumferential frame either manually or under the control of a motor 48. In an effort to reduce the required scanning time, the axial frame 46 can support up to five magnetic sensors probes 4, 6, 8, which are held and oriented to point towards the centre of a pipe section 30 under inspection. To fit larger diameter pipes, the curved ends 42, 44 may be replaced, or an adjustable system can be used.

The mechanical support system 10 enables mechanical movement in circumferential and axial directions around a section of pipe 30. Probes 4, 6, 8 are moved along the axial and around the circumference of the vessel whilst magnetic data is collected by the application. The support and/or control provided by the mechanical support system 10 helps to ensure that passes are completed as intended during inspection. This is particularly helpful when longer passes, such as illustrated in FIG. 3, are used. However, perfectly satisfactory results were found to be obtainable using a manual inspection method.

With the motor-operated method, the location of magnetic data collected can be determined based on time and speed of the probe movement. This is an efficient solution because the time and movement speed of the motor are both known. The data location is calculated using the following two formulae:

$${S}_{0} = 1 / 2 {at}^{2} + {v}_{0} t$$

$${S}_{1} = {v}_{1} {t}_{1}$$

S₀ represents distance during acceleration, a is the acceleration, t is acceleration time and v₀ is start speed (0 mm/s)

S₁ represents distance during constant speed, v₁ is maximum speed and ti is the duration of time moving at constant speed.

A configuration file is included in the application from which these calculation parameters can be viewed following a motor-operated scan.

For a manual method of collection, the location can be calculated using the beginning and end clock position of each pipe scan, in conjunction with the pipe radius. This distance is then interpreted along with collected magnetic data.

The rate for locational data collection most commonly used to date in this project is 10 Hz, i.e. 0.1 second time interval between collections. This rate is used alongside the pipe radius to interpret the length of each scan. Experimental results using this method of locational data collection show that, to date, the largest possible imprecision in terms of actual location is approximately five centimetres circumferentially. This figure has been deemed acceptable for current use, but efforts are being made to reduce it during further development.

In order for the application to correctly calculate the location of each collected dataset using this method, a configuration file has been included. The parameters within this file are manually configured by the operator prior to completing the data collection. Required inputs are pipe radius, pipe wall thickness, scan start and end clock positions.

A laser positioning module has also been incorporated and tested as part of the probe. This provides a more accurate, and lower risk, method for measuring locational data by measuring distance travelled at the source rather than relying on calculations and a constant speed probe movement over the inspected section of pipe. However, the laser positioning method requires a smooth scanning surface with very little interruption in constant probe movement, which may render it unsuitable for ex-operational samples, for example, the surfaces of which can be uneven. Since the invention does not relay on direct contact with the pipe wall during inspection, the problem may be mitigated by the introduction of a smooth temporary surface between the target pipe and the sensors probe 4, 6, 8.

An alternative mechanical support frame 10A, specifically for supporting and assisting with manual movement of probes, is illustrated in FIGS. 4A and 4B.

The alternative mechanical support frame 10A comprises a plurality of articulated frame sections 42A which together form a curved support frame that can wrap around a section of pipe 30, 30′ for inspection and support sensor probes 4, 6 around the circumference. The alternative mechanical support frame 10A maintains sensor probes 4, 6 at a fixed circumferential spacing, but does not comprise any axial support elements for guiding motorised or manual axial movement of the probes 4, 6. Instead, handles 49 are provided so that an operator can move the probes 4, 6 along the pipe section 30, 30′ by hand.

The alternative mechanical support frame 10A has a modular design and can accommodate a varying number of probes 4, 6 and/or adjust to a variety of different diameter pipe sections 30. For example, FIGS. 4A and 4B show the same configuration of the alternative mechanical support frame 10A, with five articulated frame sections 42A, supporting two sensor probes 4, 6. The articulation of the alternative mechanical support frame 10A allows it to conform to the larger diameter pipe section 30 of FIG. 4A and the smaller diameter pipe section 30′ of FIG. 4B. Clearly, alternative mechanical support frame 10A as shown covers far less of the wall of the larger diameter pipe section 30. However, additional frame sections 42A could be added to allow the support frame 10A to extend around more of the circumference if desired.

Additional sensor probes 4, 6 could also be provided on a longer support frame 10A to the point where it can scan the full circumference of the pipe in a single pass.

In order to minimise interference in the magnetic field readings, the frame elements 42, 44, 46 are formed of Aluminium, carbon fibre or other non-magnetic material, and the motors and computer-controlled units are maintained at a distance of at least 200 mm from any probe at all times. Any motorised drive may be battery powered and the minimum speed of movement for the probe(s) may be 50 mm/s. The minimum spatial resolution may be 5 mm.

The data logger 2 records the collected magnetic data measured by the probe(s) 4, 6, 8. It is able to support multiple probes, providing high-speed connection to a bespoke software application for data transmission. The data logger 2 may be battery powered, and be designed with a low power consumption for the reasons already discussed.

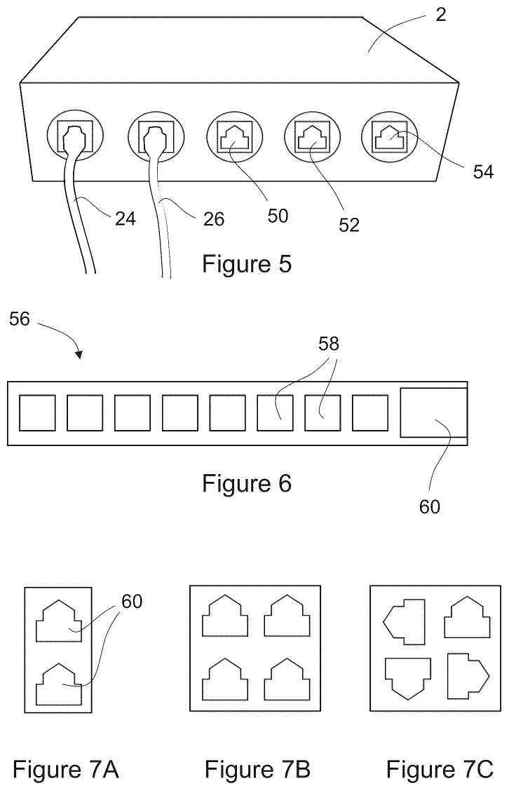

FIG. 5 illustrates a data logger 2 showing connections to two sensor probes 4, 6, which in the example are two lengths of ethernet cable 24, 26, although it should be clear that other types of cable suitable for data transfer could be used. The data logger 2 also provides additional connection ports 50, 52, 54 and is capable of supporting up to five probes 4, 6, 8 if required. The data logger 2 integrates a routing function that allows direct connections to the host computer and the mechanical system 10 used for data collection.

Twisted cable 24, 26 is used in the example to connect the magnetic sensors probes 4, 6, 8 to the data logger 2. A cable length of two metres is currently being used. Probe functions and readings are improved if the probe can be operated at least one metre away from the data logger, because this reduces the risk of noise/interference in the sensor readings. To further mitigate these issues, the/each probe 4, 6, 8 is designed to have low power consumption and to draw this power from the data logger 2 so that no integrated power supply is required within the probes 4, 6, 8. The example data logger 2 is powered by a rechargeable battery and can continuously operate over five hours before recharging, although other power sources may be considered.

The way in which the magnetic sensors should be arranged or configured within the sensors probe to give the best results will likely vary for different applications of the system.

Therefore, design flexibility and adaptability are important considerations when designing the instruments making up the system, to allow later modifications. However, it is preferred to have a probe of magnetic sensors that maps the required magnetic field on at least two layers, in radial direction, of the target pipeline. The first layer of magnetic sensors should be positioned as close as possible to the insulation (or pipe) surface during use, with subsequent layers then being spaced from the first layer in the radial direction.

Example arrangements of sensors within a probe 4, 6, 8 are shown in FIGS. 6-7C.

Each layer of sensors in the illustrated example array 56 of FIG. 6 provides support for eight three-axis magnetic field sensors/magnetometers 58 providing a measurement range of +/−0.8 mT, a measurement sensitivity of 100 nT and a spatial resolution of 10 mm. Each sensor 58 is 5.0 mm square and the sensors 58 are centred at 10 mm spacings. The small dimensions help to minimise the size of the final probe (probe sizes of L100 mm×W40 mm×H25 mm are achievable) and to achieve a good spatial resolution. A connection port 60 is also provided at one end of the array 56 for connection to a cable 24, 26 allowing connection to a data logger 2.

The magnetic field needs to be consistently measured at many layers in a radial direction, with a spatial resolution of a few millimetres in order to fully explore the magnetic field in the volume around the target pipeline.

Each array 56 has therefore been designed to be accommodated with other arrays in a sensors probe 4, 6, 8. By providing two or more arrays 56 in spaced layers, a single probe 4, 6, 8 can provide arrays 56 positioned at different heights above a target section of pipe 30 in use, with the intention of efficiently mapping the collected magnetic field in three dimensions.

Several options are available for combining multiple arrays 56 within a single probe 4, 6, 8, and some examples are provided in the schematic end views of FIGS. 7A-7C, taken from the connection end 60. FIG. 7A shows a pair of arrays 56 simply layered one above another, while FIG. 7B shows a square arrangement providing two layers of two arrays 56. If each array includes eight magnetic sensors, arranged as in FIG. 6 for example, then the probe 4, 6, 8 can provide 3D measurement, measuring a magnetic field at thirty-two points simultaneously.

An alternative arrangement of four arrays 56, with two rotated through ninety degrees, is shown in FIG. 7C. It will be understood that different configurations and larger numbers of arrays could also be provided within a single probe if required.

The device and system described provides a means for processing magnetic images and allows the development of techniques to extract magnetic signatures of defects.

A software application, called ‘cuitools’ and developed in Python, supports simultaneous communications with multiple arrays of sensors. Data is collected by the application and saved to .csv files for later analysis. The collected magnetic data can be visualised on site by the operator.

A.csv file is created for each magnetic dataset collected, and is uniquely identified. For the motor-operated collection process the naming protocol incorporates the specific sensor array IP address used suffixed by an increasing last digit, beginning at 0 for the first scan, for example, ‘line_192.168.0.101.0.csv’, ‘line_192.168.0.101.1.csv’, ‘line_192.168.0.101.2.csv’, etc. Within each .csv file, the application stores one sample of collected raw data per row, in hexadecimal format. Hexadecimal format cannot be interpreted manually, so a separate function has been developed to read and unpack this stored raw data for later analysis.

When employing the manual method of data collection, a different naming system is used, and constitutes ‘sensor array identification+magnetic field axis+scan number’. For example, ‘sarr0.bx.0.csv’ refers to the first sensor array, magnetic data in X axis and the first scan. One.csv file is created for each magnetic field axis per sensor array, per scan. Therefore a Sensor Probe containing two sensor arrays will provide six.csv files per scan.

The application requires a different command for manual data collection than that required for motor-operated collection. The manual command has been developed to automatically interpret the hexadecimal format raw data collected and convert to decimal format which enables manual interpretation.

A function within the application enables the display of collected magnetic data in line chart format alongside time. A graph may be created with four separate subplots showing X, Y and Z magnetic field axis values along with the total raw magnetic signal from that dataset. This allows the operator to visualise changes in magnetic data as the probe crosses the target pipe.

The system also provides for further processing to provide two and/or three dimensional plots of magnetic field data over the area or section of pipe being inspected, as discussed further in the experimental results below.

The device and system have been tested under various different conditions. For the testing, a probe 4, 6, 8 comprising a simple two-layered arrangement of arrays 56, similar to that shown in FIG. 7A, was used. The testing can be broken down into three categories, as outlined below:
1. Laboratory-based measurements on two 6-inch vessels, one of which is free from defects and the other having artificial metal losses created using an electro-etching process.
2. On site measurements completed on three out-of-service pipe sections, none of which have defects
3. Measurements completed off site at a validation centre of a decommissioned pipe sample with multiple defects.

The addition of decommissioned pipes to the initial lab-based study was thought to add significant value to the project by enabling laboratory-based testing to be expanded early in its development into an operational environment.

For the sake of brevity, only the results from the electro-etched vessel from Category 1 (Sample 1) and the decommissioned pipe from Category 3 (Sample 2) will be discussed below.

During the testing process the target pipe was covered with thin plastic sheet, which had been marked with a scanning ‘grid’. The scanning grid consisted of a series of lines, separated by 85 mm, drawn across the width of the plastic sheet to be placed axially along the target pipe. The scanning path followed during testing was therefore similar to that illustrated in FIG. 2.

The length of each 85 mm strip used in testing was selected to be equal to the length of the particular sensors probe 4, 6, 8 used (it will be understood that other lengths would be appropriate for probes of different dimensions). Each line on the grid thus represented the top position of the probe during each scan, in order to ensure the entire pipe surface was included in the full dataset collection.

After positioning the scanning grid on the target pipe section 30, the magnetic field data was collected manually using the sensors probe 4, 6, 8. The operator moved the probe 4, 6, 8 manually along each cross-section, in circumferential direction across the target pipe until the entire inspection area had been covered.

Throughout the data collection process, magnetic and positional data were recorded by the purpose-built data logger 2 and transmitted to the bespoke software application running on a host laptop, for display, storage, processing and analysis purposes.

Sample 1 was a 6-inch pipe measuring 1.8-metres in length. It was capped throughout the tests and pressurised up to 40 MPa for a period of a few days prior to data collection. Pressurisation was required in order to enhance Stress Concentration Zones (SCZ) around defect areas, with the aim of producing a detectable magnetic anomaly.

Sample 1 included five external metal loss type defects. These defects were created through a process of electro-etching, with diameters ranging from 20 mm to 40 mm, intended to represent corrosion. The following table characterises each of the induced defects and lists their relative clock position on the pipe.

| | Distance from | Defect | Wall Thickness | |
|---|---|---|---|---|
| Defect | Pipe Start | Diameter | Loss | Clock |
| ID | (mm) | (mm) | (mm) | Position |
| 1 | 510 | 25 | 3 | 9 |
| 2 | 720 | 30 | 2 | 9 |
| 3 | 1020 | 40 | 2 | 12 |
| 4 | 1315 | 35 | 3 | 12 |
| 5 | 1485 | 40 | 2 | 12 |

Sample 2 was a 275 mm diameter decommissioned pipe sample. The pipe remained in-situ at the validation centre for the duration of these tests, and is regularly used as a test subject for other inspection tools.

Data was collected on a 2.1 m length of Sample 2 with between 70 mm and 90 mm of insulation and galvanised steel cladding in place along the entire length. Data was subsequently collected following insulation and cladding removal, along the same length.

Sample 2 contained one bend at the end of the sample. The clock position of this bend was used as a reference point from which relative clock positions of defects present on the pipe were determined to try and ensure an accurate correlation between data analysis results and actual defect positions could take place.

During testing, it was found to be challenging to ensure that the bend in Sample 2 was located in the same position between repeat data collections after removing the insulation and cladding. Although any positional error has been deemed as insignificant, this should be taken into consideration when comparing magnetic anomalies identified in different scans with and without insulation, which are considered to be correlated with each other and verified as matches.

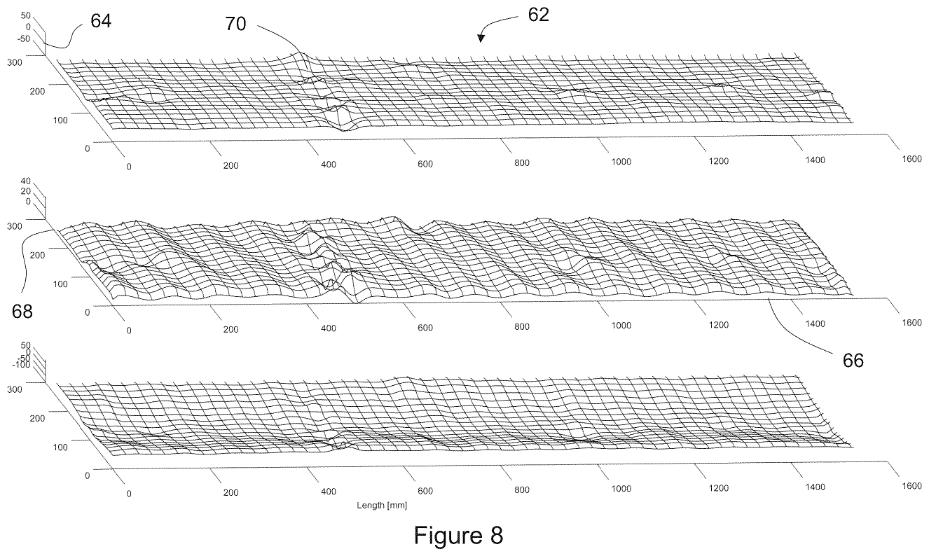

Absolute magnetic field measurements were initially used for imaging the magnetic data collected. Example images 62 collected from Sample 1 are shown in FIG. 8.

FIG. 8 separately shows three components of the measured magnetic field (Bₓ, B_{y}, B_{z}) each plotted on the vertical axis 64 against the axial length 66 and clock position 68 of Sample 1. The magnetic data shown were collected from the top half of the pipe, in the counterclockwise direction from clock positions 3 to 9. It should be noted that the units used to quantify magnetic indications represent the relative magnitude of an indication following data processing, and are referred to in this report simply as ‘units’.

Initially, it was thought that a significant challenge following data collection would be the ‘stitching’ together of individual scans in order to build the full magnetic image of the inspected pipe length. However, as can be seen from FIG. 8, each plot of which includes eighteen consecutive cross-sectional scans along the axial length 66 of the pipe of Sample 1, the boundaries between each individual scan were successfully eliminated by the data processing algorithms ensuring that the magnetic image 62 of the full inspected length could be used for analysis.

As previously mentioned, Sample 1 contained artificially induced defects in addition to a girth weld. FIG. 8 clearly shows the girth weld indication 70 at approximately 480 mm from data collection start point, and is visible across the images at all clock positions.

The aforementioned method of magnetic imaging based on absolute magnetic field measurement values does however incur unwanted influence from sources of magnetic field other than that of the target pipe. These include the Earth's magnetic field, noise resulting from movement of the Sensor Probe and interference from surrounding metallic objects. Providing a Sensor Probe that can be used at a distance from the data logger and PC helps to avoid introducing unnecessary interference during the inspection process, but the layout of many facilities means that the influence of other nearby pipes can be significant. These effects have, however, been minimised as a result of the configuration of the sensor arrays contained within the Sensor Probe, which include multiple arrays positioned above each other in layers. This allows the Sensor Probe to measure magnetic gradients which can be used instead of absolute values for interpretation purposes.

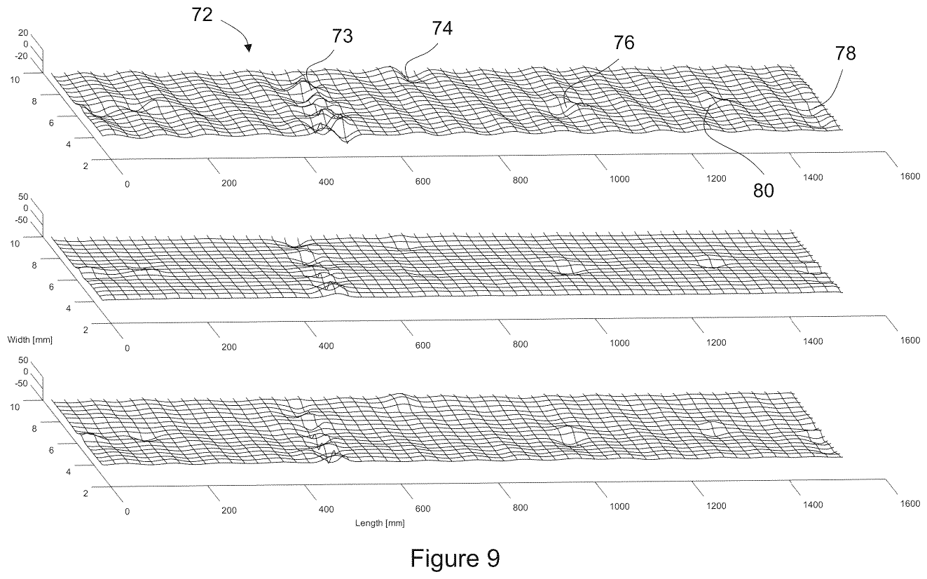

FIG. 9 shows magnetic images 72 reconstructed using collected magnetic gradients for the same dataset as that shown in FIG. 8, i.e. from Sample 1. The locations 73, 74, 76, 78, 80 of known defects on Sample 1 are also marked for reference. In this instance, magnetic gradients were calculated using magnetic samples measured from different heights at the same position on the pipe.

As can be seen in FIG. 9, using magnetic gradients rather than absolute magnetic values means that the majority of data points fluctuate around zero, i.e. 0-μT. However, at known defect areas 73, 74, 76, 78, 80 a local magnetic anomaly appears in all three magnetic field components. The strength of each magnetic anomaly varies between 10-μT and 50-μT, depending on the component.

When comparing the two imaging methods described above, it can be seen that using magnetic field gradients (FIG. 9) rather than absolute magnetic field values (FIG. 8) enhances the Signal to Noise Ratio (SNR) of the dataset, in turn augmenting the strength of magnetic anomalies at defect areas 73, 74, 76, 78, 80 relative to the background strength. These findings suggest that the arrangement of magnetic sensor arrays within the Sensor Probe, i.e. layered radially rather than provided at a single radial distance, plays a key role in determining the quality of collected magnetic data.

Although use of magnetic gradients to image collected data improves the SNR and enhances the magnitude of a magnetic anomaly at defect locations, patterns relating to the same anomaly are not consistent across all three magnetic components. This is because a Stress Concentration Zone (SCZ) caused by a defect appears as a magnetic dipole in terms of its magnetic properties. As a result, observing such dipoles in different axes through investigation of each magnetic component will show different magnetic patterns in each component.

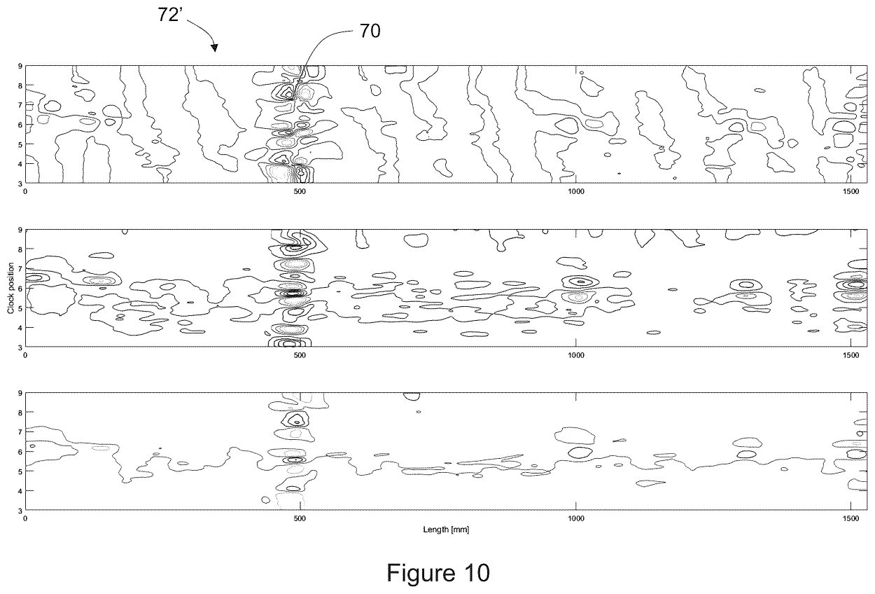

For example, FIG. 10 shows an alternative, 2-dimensional, representation 72′ of the data from FIG. 9. While there is relatively good correlation in the data for the weld location 70, clear differences can be seen between the three plots, illustrating the inconsistency discussed above.

It is undesirable for an operator to have to manually observe all three interpreted components of magnetic field collected and attempt to quickly recognise a combination of indications relating to a potential defect area. Therefore, it was deemed beneficial to provide some means of combining the aforementioned patterns to produce a single indication and simplify the interpretation of results by end users during use of the tool.

A software algorithm was developed to fulfil this requirement. The software implements two different methods (Type-1 and Type-2) for calculating indications, quickly identifying the presence of magnetic anomalies.

For a Type-1 indication, software algorithms use magnetic gradients of all three components, i.e. ΔBₓ, ΔB_{y}, ΔB_{z}, to calculate the strength of changes of gradients at all data points. For a Type-2 indication, software algorithms attempt to calculate changes of gradients on the curving surface of the inspected area.

The two indications can be used separately, or can be combined in an attempt to increase the likelihood of finding defect areas.

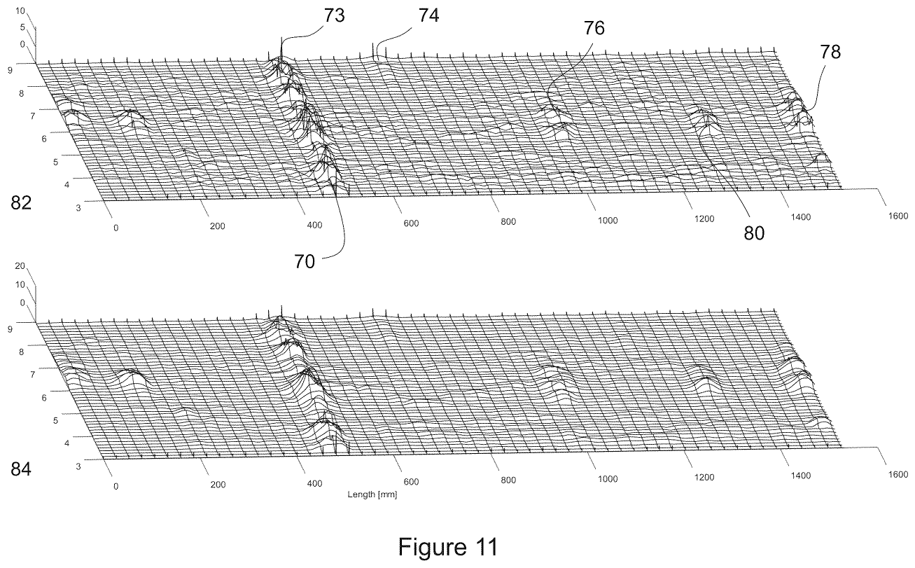

FIG. 11 shows results of the processing on data collected from Sample 1, the same dataset used in FIGS. 8-10. The top image 82 shown in FIG. 11 represents results after applying the Type-1 indication method described above, with the bottom image 84 representing results after applying the Type-2 indication method. The locations of known defects 73, 74, 76, 78, 80 are again indicated for reference on the top image 82.

It is clear to see from FIG. 11 that, in both cases, indications at defect areas 73, 74, 76, 78, 80 are stronger and more easily distinguishable against the background level. The background strength for Type-1 varied between 0 and 2 units with defect indications showing at least 4 units. The background strength for Type-2 also varied between 0 and 2 units, but defect indications showed at least 5 units. As expected, strong indications also appeared at the position of the girth weld 70, with a strength of between 14 and 16 units.

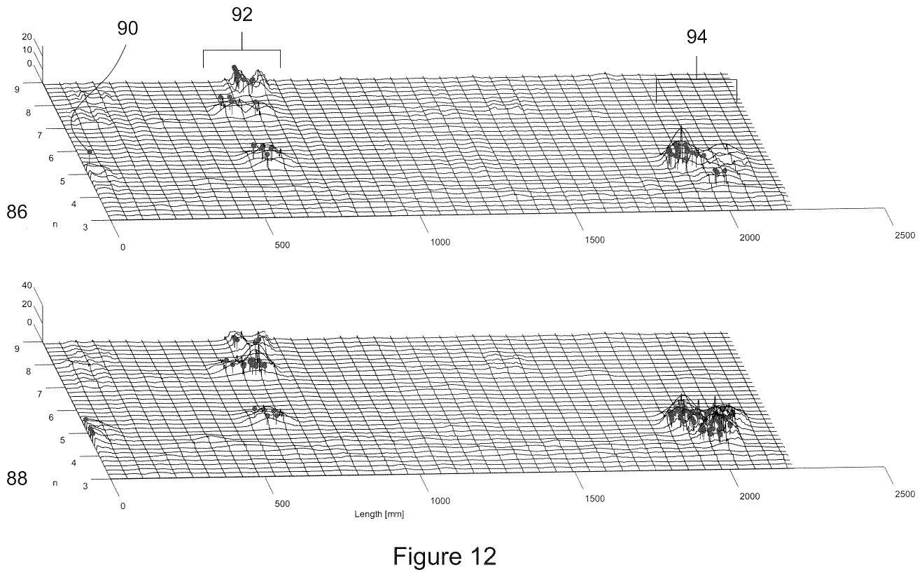

FIG. 12 shows similar indications calculated from data collected on Sample 2, without insulation or cladding. Again, the top image 86 represents results after applying the Type-1 indication method and the bottom image 88 Type-2. Dots 90, 92, 94 on the images identify indications with a strength of above 2 units, and were automatically marked by the software using a search threshold of greater than 2 units, which was assumed to be the background range.

As can be seen from FIG. 12, the indications picked up several groups of magnetic anomalies. Following visual verification of the pipe condition, it was noted that all marked Type-2 indications corresponded with actual defects or groups of actual defects present on the pipe sample. The first five groups of indications 92 identified at approximately 500 mm from data collection start point corresponded with five separate corrosion areas on the pipe sample. The last, and strongest, group of indications 94 at approximately 2000 mm from collection start point also corresponded with a group of defects at that location on the sample.

A small group of around three indications was also identified at approximately 1430 mm from collection start point, but not marked with dots on FIG. 12. It was more difficult to connect these indications to an observed defect, with nearest noted defect situated approximately 100 mm away from the indication location. It should be noted, however, that although best efforts were made, the exact clock position of data collection start and stop points is likely to vary between all scanned sections. The position of the observed defect closest to these indications was between 3 o'clock and 4 o'clock and it proved difficult to conclusively trace back to confirm whether the data collection covered this area directly during the dataset presented.

It can also be noted in this instance that the Type-1 indications include a greater number of weaker indications than Type-2 indications. All weaker indications were above the threshold of 2 units and less than 10 units but did not correspond with any observed defects, rendering them false calls.

The aforementioned indications can be thus be used to detect the presence and locations of defects by identifying magnetic anomalies appearing around a defect area subjected to stress. There also appears to be a link between the stress level a pipe has been subjected to and the subsequent strength of identified indications.

When introducing insulation to the test, it was important to consider the increased distance between the sensors probe and target pipe when collecting magnetic data. Increased distance from the magnetic source leads to a reduction in magnetic field strength, which in turn will lead to a decay in indication strength.

During testing on Sample 1, an increase in distance between the probe 4, 6, 8 and pipe surface of 40 mm resulted in both Type-1 and Type-2 indications dropping to less than 1 unit. Only weak indications at the defect areas could be seen when reducing lift-off distance to 30 mm.

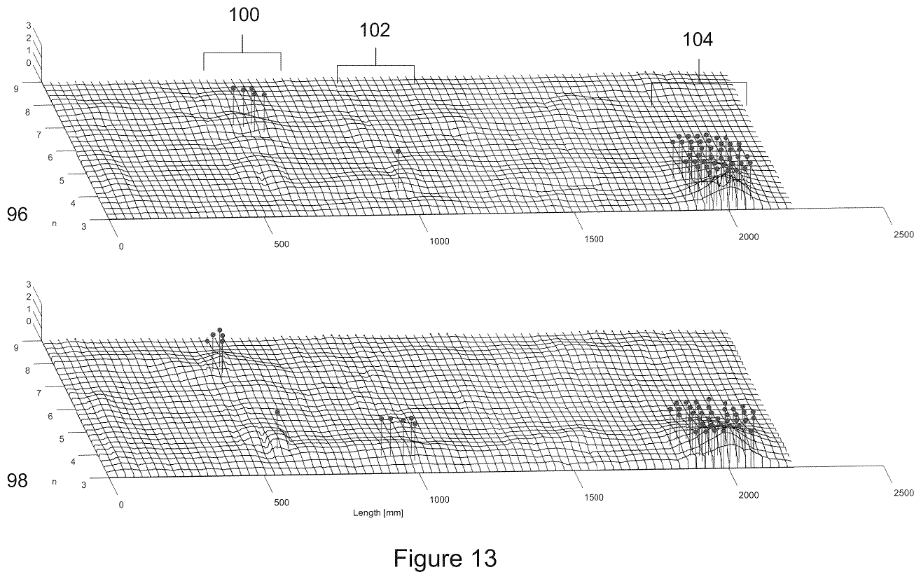

However, when increasing lift-off to approximately 90 mm during data collection on Sample 2 (due to the presence of insulation and cladding), indications representing defect areas were still present. This can be seen in FIG. 13, which again shows the Type-1 indications in the top image 96 and the Type-2 indications in the bottom image 98. It should also be noted that a there was a significant amount of time between data collections with and without insulation on Sample 2. As noted above, the testing was first conducted on the insulated pipe to provide the results shown in FIG. 13, before the insulation and cladding was removed to obtain the results shown in FIG. 12. This action led to the pipe being rotated, and partly due to the delay the pipe was not repositioned correctly to provide exactly the same orientation for both dataset collections. This in turn led the actual defect positions varying between the two datasets in FIGS. 12 and 13. Dots 100, 102, 104 are again included in the plots shown in FIG. 13 to highlight indications of greater than 0.5 units.

Despite the change in orientation, it can be seen when comparing FIG. 12 and FIG. 13 that indications at 500 mm and 2000 mm were still identified when 90 mm of insulation and cladding was in place. These two groups of indications 100, 102 were the strongest detected from data collected without insulation, measuring up to 100 units. With the insulation in place, the same indications measured only approximately 3 units.

The experimental results indicate that defects in a pipe wall, including external corrosion, produce Stress Concentration Zones (SCZs) and resulting magnetic anomalies which can be detected by observing the passive magnetic field induced by a subject pipe. It follows that any type of defect causing a SCZ in a pipe wall may also be detected in this way.

There is solid evidence following these tests that indications calculated using the gradient magnetic field from a pipe without defects present would result in a small range of indications insignificant from background values. Conversely, there is evidence to suggest that indications calculated from a pipe with defect areas would be distinguishable from the background. It is also thought that the magnitude of contrast between a defect indication and the background values depends on the target pipe material type, stress history and distance between the probe 4, 6, 8 and target pipe 30.

The algorithms developed are able to identify both welds and defects under insulation, and an operator could ascertain whether an indication likely relates to a weld or a defect by comparing locational data of an indication. That is to say a weld indication would appear across all clock positions whereas a defect may only be present at one clock position. This is a benefit of mapping the entirety of a wall section under inspection. Accurate determination of weld locations can also be beneficial for any planned maintenance, by providing a clear reference point to help locate a defect or similar on the pipe wall.

The strength of indications is affected by the distance between the Sensor Probe and target pipe, so there must therefore be a maximum threshold of insulation thickness for each pipe type at which the tool developed can no longer collect usable magnetic data. However, the tool has been shown to be effective for commonly used insulation and cladding thicknesses and materials. The limit in any specific instance will depend on various factors including pipe size, material and stress history. A database containing tested pipe parameters alongside maximum insulation thickness could be kept to provide an indication of maximum inspection distance (lift-off) for a variety of scenarios. The database could be used by the software to determine whether a proposed target pipe is within the scope of the technology with regards to insulation thickness, prior to data collection, and/or to provide an indication of Sensor Probe design or power required for a particular inspection.

In some instances, depending on distance between the probe 4, 6, 8 and target pipe 30 as well as the distance between adjacent points of corrosion etc, the software may group adjacent defects as one indication rather than as a number of discrete defects. In practical terms, however, this is not seen as problematic because the location requiring remedial action or visual inspection will still be clearly identified.

Ideally, the system would be capable of identifying corrosion at any position on the wall of a pipe with a sweep of just half the pipe circumference as already described, i.e. without necessarily collecting data from directly above the defect. In other words, data collection between 3 o'clock and 9 o'clock (i.e. along the top half of a pipe) would ideally be able to also detect a defect located at 6 o'clock (the bottom of the pipe). Testing has not yet provided clear evidence to show this functionality, possibly due to a domination of the collected magnetic field by the top half of a pipe when the Sensor Probe is in close proximity. However, only one dataset used for analysis so far included known defects at the six o'clock position, so there is insufficient data to dismiss the possibility. Future developments and improvements in sensor sensitivity and noise level and/or improved Sensor Probe design are expected to improve the detection and provide the desired result.

In any case, the current Sensor Probe design has been reduced in size in order to enable data collection in a variety of pipe network configurations, including underneath pipes in confined spaces and on vertical and parallel pipes. This mitigates any possible shortcomings in the current sensitivity, still allowing complete inspection. It is also intended to provide alternative Sensor Probes or arrays shaped to largely or completely surround a pipe's circumference so that the inspection can be made in a single pass where access allows.

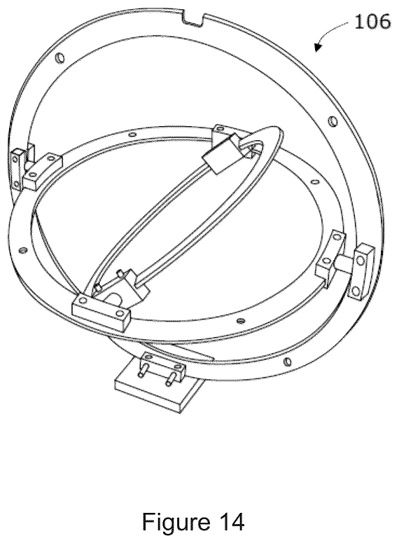

Calibration of the sensors is important, partly due to the relatively large number of individual sensors used. The calibration can be carried out individually prior to arrangement in a probe, or an entire probe 4, 6, 8 can be assembled and then calibrated. An example rig 106 for calibration of a probe is shown in FIG. 14, and essentially comprises a three gimbals mounted with orthogonal pivot axes. A probe 4, 6, 8 received in the rig 106 can thus easily be rotated in three dimensions while a bespoke calibration routine is run.

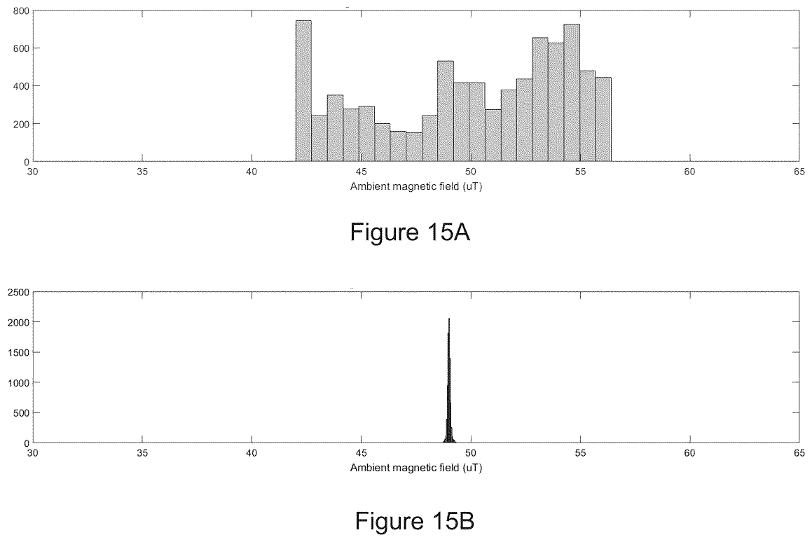

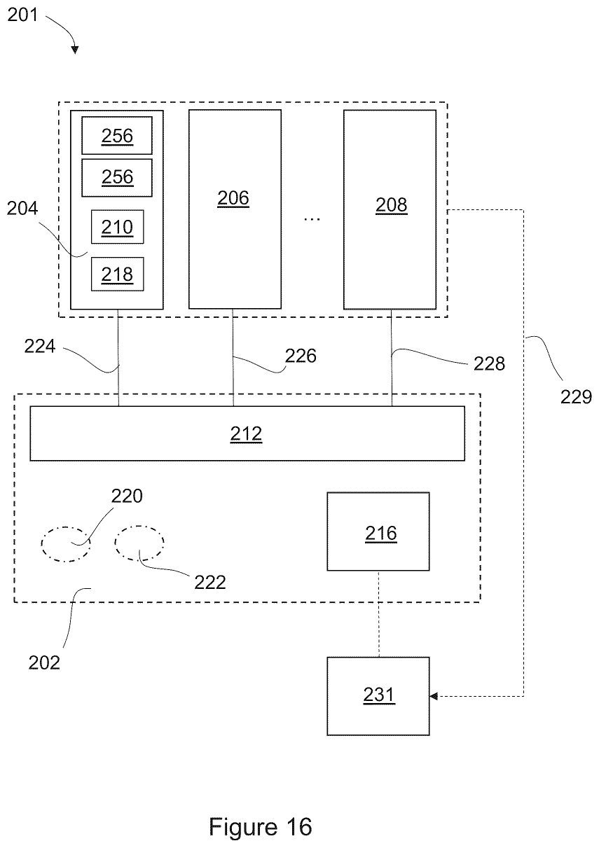

Example results of the calibration process are shown in the charts of FIGS. 15 and 16, which show the spread of readings before and after calibration respectively. The error of magnetic sensor readings is reduced by at least ten times (from over 5 μT down to less than 0.5 μT), and the standard deviation of all readings is reduced by at least five times (from over 2 μT to less than 0.4 μT). The calibration parameters of each individual sensor are stored, and the required correction can then be automatically applied to readings during subsequent use of a probe.

The inspection system and method described above provide benefits in detecting corrosion under insulation (CUI) and/or other potential hidden defect in sections of pipe in environments that typically make inspection difficult. A system for ongoing monitoring could also be provided by positioning a circular or ring-shaped array of sensors at a set location. The sensor design and arrangement could be essentially as already described, but with the arrays of sensors arranged in concentric rings rather than parallel substantially flat layers.

Where an indication of CUI or some other defect in the pipe has been detected at a relatively minor level, monitoring apparatus of this type would allow ongoing monitoring of the relevant positions within a network of pipes to confirm the presence of and/or monitor the degradation of the defect. Threshold values could be set, and alarms or alerts triggered if the previously detected indications were to rise to a level indicating a problem requiring maintenance or visual inspection. By allowing ongoing monitoring of potential problem areas, the number or frequency of full inspections could be reduced, reducing costs and improving the facility's efficiency of operation.

A wireless communication option between the Data Logger and software running on a host laptop will enable the operator to move more freely. The embedding of software algorithms into a smaller handheld device, such as a tablet or smartphone, makes the overall system more portable and, for example, facilitates working at height.

A schematic diagram of an alternative example inspection system 201 is shown in FIG. 16. The system 201 is particularly, but not exclusively, intended to operate without mechanical support of guidance of a probe 204, 206, 208 during the inspection operation.

The inspection system 201 of FIG. 16 includes one or more ‘smart’ probes 204, 206, 208, a remote controller 202 and a remotely located data processor 231, which may be realised as software running on a host computer, tablet, or laptop, for example.

Each smart probe 204, 206, 208 in the illustrated system 201 includes layered arrays 256 of magnetic field sensors, along with an inertial measurement unit (IMU) 210 to measure triaxial acceleration and triaxial angular velocity of the probe 204, 206, 208. A data transmitter 218 is also provided to allow each probe 204, 206, 208, to transmit magnetic field data and motion data directly to the processor 231 for processing and/or display and/or storage on a data carrier. The data logger is thus effectively distributed between the probes probe 204, 206, 208 and the processor 231, rather than being provided in a standalone component. The direct transfer 229 may be provided by a wired or wireless connection.

The remote controller 202 includes a power supply 212 to power the or each smart probe 204, 206, 208 via an electronic cable 224, 226, 228. As shown, a single remote controller 202 is shown with a number of smart probes 204, 206, 208, and so the power supply 212 may comprise a battery and a distribution rail or similar as shown in FIG. 1. However, it is also envisaged that each smart probe 204 could have its own dedicated remote controller 202, and that the power supply 212 could simply comprise a rechargeable battery or similar. As previously discussed, providing a power supply 212 that can be maintained at a distance, preferably 1-2 metres, from the sensor arrays 256 is beneficial in minimising electromagnetic interference in the sensor readings from the probe(s) 204, 206, 208.

The remote controller 202 also provides a user interface, typically including one or more user operated buttons 220 to remotely control functions of the processor 231, for example to start and stop recording, mark the start and end of an inspection sweep/movement etc, and one or more indicator lights 222. The remote controller 202 may be connect to the processor 231 via a wired or wireless connection so that input and or control data 216 can be transmitted.

The system 201 as described allows both magnetic field data and motion data to be transmitted directly from a probe 204, 206, 208 to a processor 231, along with control and/or user input data from a remote controller 202. The processor 231, and associated software algorithms, can then generate a visualisation for display and/or can perform analysis on the data and detect/identify regions of corrosion or other defects for the region of pipe under inspection. The visualisation may take the form of a full two-dimensional magnetic field representation of pipe section comprising magnetic field data measured in multiple scan paths/sweeps, and can be provided in real time, for example on the display of a laptop or tablet or on a separate dedicated display device, They may additionally, or alternatively, be stored for subsequent reproduction or further processing. The analysis can provide defect detection on site, as well as recording data for further subsequent analysis.

The use of mechanically supported, guided and/or driven mechanisms to control and regulate movement or sensors during an inspection can be problematic where access to a pipe section is obstructed. In such circumstances, manual inspection using a small, easily manipulable hand-held probe provides a solution allowing inspection of otherwise inaccessible areas. However, a significant drawback of such manual data collection is that, without the benefit of a mechanical guide or similar form of control, the magnetic field data collected in each scan path or sweep is subjected to uncertain factors including changes in probe movement speed, uneven distance between the target pipe and the probe, or inconsistent start and stop locations. The system 201 compensates for this by processing the collected data to minimise impact of the uncertainties.

The data processing involves scaling the measured magnetic field into a pre-determined two-dimensional image at a pre-determined spatial resolution by software algorithms.

By using acceleration data obtained from the inertial measurement unit (IMU) 210, the algorithm can determine whether a probe 204 is moving or stationary, helping to remove unwanted data samples that might arise when an operator has to pause to reposition themselves mid scan because of an obstruction in the vicinity of the pipe. The speed of each probe 204, 206, 208 during the or each scan path can also be recorded, and because the time duration of each scan is known by the algorithm (for example from a user input at the interface 220), the actual length of the scan path can then be simply calculated.

Magnetic field data of scans are processed to eliminate inconsistence between scans in terms of coordinates, scan speed, and number of data samples due to manual movement, and stitched together to generate a 2D representation of the scanned area up to that point. Because a scanning path will be predefined, the position/order of each scan/sweep to be combined in the full representation of the inspected pipe section will be known. By also obtaining/deriving the actual scanning length, the number of data samples, and the dimensions of the pre-determined two-dimensional image, interpolation algorithms can then be applied to scale the magnetic field data into the pre-determined two-dimensional image and overcome the drawbacks of manual inspection. Furthermore, the motion data from the IMU 210 may also be used to minimise impact of rotation of the probe 204 during scanning.

It will be understood that various aspects of the system 201 shown in FIG. 16 could also be applied to the system 1 previously described in FIG. 1 and vice versa. For example, the inclusion of an IMU 210 in the probes 4, 6, 8 of the FIG. 1 system 1 would provide similar benefits, whether or not the data was transferred via a centralised data logger 2 or a more distributed system as in FIG. 16. Using wireless connections wherever possible also helps to allow unimpeded movement of a probe, further improving the versatility of the inspection system.

Various other modifications would also be apparent to a skilled reader. As such, it is emphasised that the forgoing description is provided by way of example only, and is not intended to limit the scope of protection as defined with reference to the appended claims.

1. An inspection system for detecting and mapping magnetic anomalies in a section of pipe, the inspection system comprising:
a probe comprising a plurality of magnetic field sensors; and
a data logger for recording collected magnetic data measured by the magnetic field sensors;
wherein:
the probe comprises first and second arrays of magnetic field sensors arranged in first and second layers respectively, and configured such that, in use, the second layer of magnetic field sensors is spaced from the section of pipe under inspection by a greater radial distance than the first array of magnetic field sensors.

2. The inspection system according to claim 1, wherein one or both of the first array and the second array comprise 4, 8, or 16 magnetic field sensors.

3. The inspection system according to claim 1, wherein the probe is configured to measure a magnetic field gradient in the section of pipe.

4. The inspection system according to claim 1, wherein each of the first and second layers contains a plurality of magnetic field sensors, and the arrangement of magnetic field sensors in the first array is the same as the arrangement of magnetic field sensors in the second array.

5. The inspection system according to claim 1, further comprising a power source for the probe, wherein the probe is remote from the power source.

6. An inspection system for detecting and mapping magnetic anomalies in a section of pipe, the inspection system comprising:
a probe comprising a plurality of magnetic field sensors; and
a data logger for recording collected magnetic data measured by the magnetic field sensors;
wherein:
the probe comprises first and second arrays of magnetic field sensors arranged in first and second layers respectively, and configured such that, in use, the second layer of magnetic field sensors is spaced from the section of pipe under inspection by a greater radial distance than the first array of magnetic field sensors; and
the probe comprises an inertial measurement unit to measure motion of the probe, and a data transmitter configured for transmitting magnetic field data and motion data from the probe to a processor component.

7. The inspection system according to claim 6, further comprising a remote controller with a user interface configured for controlling the probe and/or the processor component.

8. An inspection system for detecting and mapping magnetic anomalies in a section of pipe, the inspection system comprising:
a probe comprising a plurality of magnetic field sensors;
a data logger for recording collected magnetic data measured by the magnetic field sensors; and
a mechanical support configured for guiding or constraining movement of the probe relative to a section of pipe during inspection;
wherein:
the probe comprises first and second arrays of magnetic field sensors arranged in first and second layers respectively, and configured such that, in use, the second layer of magnetic field sensors is spaced from the section of pipe under inspection by a greater radial distance than the first array of magnetic field sensors.

9. An inspection system for detecting and mapping magnetic anomalies in a section of pipe, the inspection system comprising:
a probe comprising a plurality of magnetic field sensors;
a data logger for recording collected magnetic data measured by the magnetic field sensors; and
a mechanical support configured for guiding or constraining movement of the probe relative to a section of pipe during inspection;
wherein:
the probe comprises first and second arrays of magnetic field sensors arranged in first and second layers respectively, and configured such that, in use, the second layer of magnetic field sensors is spaced from the section of pipe under inspection by a greater radial distance than the first array of magnetic field sensors; and
the mechanical support comprises a powered drive configured for moving the probe.

10. The inspection system according to claim 1, further comprising a processor for processing the magnetic field data.

11. The inspection system according to claim 10, wherein the plurality of magnetic field sensors comprises a plurality of three-axis magnetometers which detect three orthogonal components of a magnetic field, and wherein the processor resolves the three components of magnetic field data from the three axes to calculate a single numerical value for each reading.

12. The inspection system according to claim 10, wherein the processor arranges the processed collected magnetic data based on location to provide a visual representation or map of the section of pipe under inspection.

13. The inspection system according to claim 11, further comprising a display for displaying a graphical output of the processed collected magnetic data.

14. The inspection system according to claim 11, wherein the probe is configured to accommodate the circumference of the section of pipe under inspection.

15. A method of inspecting a section of pipe, the method comprising the steps of:
A. moving a probe comprising a plurality of magnetic field sensors along a predefined path over a selected section of pipe, the predetermined path being spaced from the surface of the pipe;
B. collecting magnetic field data and corresponding location data during the movement; and
C. compiling a graphical representation of the magnetic field over the selected section of pipe from the magnetic field data and location data.

16. The method according to claim 15, wherein step A comprises moving the probe in a serpentine path over the selected section of pipe.

17. The method according to claim 16, wherein step A comprises first moving the probe in a direction along the length of the selected section of pipe.

18. The method according to claim 16, wherein step A comprises first moving the probe in a direction around the circumference of the selected section of pipe.

19. The method according to claim 15, wherein step A comprises manually moving an unsupported probe.

20. A method according to claim 15, wherein steps B and C are performed substantially in real time during movement of the probe in step A.

21. The method according to claim 15, further comprising the steps, after at least steps A and B, of:
D. identifying an anomaly in the magnetic field data;
E. determining the location of the identified anomaly on the selected section of the pipe; and
F. positioning a static probe comprising a plurality of magnetic field sensors at said location.

22. The method according to claim 15, further comprising a first step of performing a calibration operation on the probe.

23. The method according to claim 15, wherein the method is performed using an inspection system for detecting and mapping magnetic anomalies in a section of pipe, the inspection system comprising:
a probe comprising a plurality of magnetic field sensors; and
a data logger for recording collected magnetic data measured by the magnetic field sensors;
wherein:
the probe comprises first and second arrays of magnetic field sensors arranged in first and second layers respectively so configured such that, in use, the second layer of magnetic field sensors is spaced from the section of pipe under inspection by a greater radial distance than the first array of magnetic field sensors.

24. A data carrier comprising machine readable instructions for the operation of one or more processors to:
receive magnetic field data and corresponding location data during movement of a probe comprising a plurality of magnetic field sensors over a selected section of pipe; and
stitch the received data together to provide a graphical representation of the magnetic field over the selected section of pipe.

25. The data carrier according to claim 24, wherein the graphical representation comprises a three dimensional plot over an area representing the wall of the selected section of pipe.

26. The data carrier according to claim 24, wherein the machine readable instructions for the operation of one or more processors further comprise instructions to process separate components of magnetic field data at each location to provide a single reading at each location.

27. The data carrier according to claim 24, wherein the machine readable instructions for the operation of one or more processors further comprise instructions to calculate defect indications and determine location of defects using components of magnetic field.

28. The data carrier according to claim 24, wherein the machine readable instructions for the operation of one or more processors further comprise instructions to receive movement data during movement of said probe.

29. The data carrier according to claim 24, wherein the machine readable instructions for the operation of one or more processors further comprise instructions to calibrate magnetic field sensors and/or an inertial measurement unit in the probe.

30. The data carrier according to claim 24, for use in a method of inspecting a section of pipe, the method comprising the steps of:
A. moving a probe comprising a plurality of magnetic field sensors along a predefined path over a selected section of pipe, the predetermined path being spaced from the surface of the pipe;
B. collecting magnetic field data and corresponding location data during the movement; and
C. compiling a graphical representation of the magnetic field over the selected section of pipe from the magnetic field data and location data.
